(19) United States
(12) Patent Application Publication
(10) Pub. No.: US 2020/0384934 A1
(43) Pub. Date: Dec. 10, 2020

(54) SHOCK ABSORBING STRUCTURE FOR VEHICLE

(71) Applicant: MAZDA MOTOR CORPORATION, Hiroshima (JP)

(72) Inventors: Taiki YOTSUYANAGI, Aki-gun, Hiroshima (JP); Hiroaki TAKESHITA, Aki-gun, Hiroshima (JP); Chikara KAWAMURA, Aki-gun, Hiroshima (JP); Tsuyoshi NISHIHARA, Aki-gun, Hiroshima (JP)

(73) Assignee: MAZDA MOTOR CORPORATION, Hiroshima (JP)

(21) Appl. No.: 16/970,743

(22) PCT Filed: Feb. 18, 2019
(86) PCT No.: PCT/JP2019/005893

§ 371 Date: Aug. 18, 2020

(30) Foreign Application Priority Data
Feb. 28, 2018 (JP) 2018-035360

(51) Int. Cl. B60R 19/18

(52) U.S. Cl. CPC B60R 19/18; B60R 2019/1853

(57) ABSTRACT

A shock absorbing structure for a vehicle 1 is provided which includes a bumper beam 67 connecting together a pair of shock absorbing members 61, 61 made of a fiber-reinforced resin. The shock absorbing member 61 includes an upper wall portion 62a, a lower wall portion 62b, a side wall portion 62c having a recess 63, an upper flange portion 62d, and a lower flange portion 62e, and a vehicle-width-direction outer side is open. An outer edge portion 62o extends in a front-rear direction, an inner edge portion 62i extends in an inclined manner, and a width of each of the upper wall portion 62a and the lower wall portion 62b is wider on a rear side than a front side. Step portions 64 make an interval between the upper wall portion 62a and the lower wall portion 62b become narrower on a vehicle-width-direction inner side than the vehicle-width-direction outer side.

### TECHNICAL FIELD

The disclosed technique relates to a shock absorbing structure for a vehicle that includes a shock absorbing member made of a fiber-reinforced resin.

### BACKGROUND ART

In related art, a crash can (also referred to as crash box) has been known as a shock absorbing member absorbing energy in a collision. Further, a crash can made of a fiber-reinforced resin has been known. Crash cans are disposed in a front portion and/or a rear portion of a vehicle body in a form of a left-and-right pair and connect a bumper beam extending in a vehicle width direction.

Such a shock absorbing member is requested to manage various collisions. For example, when a collision from a front occurs to a portion on a vehicle-width-direction inner side of connecting portions of left and right shock absorbing members in a bumper beam (central portion) (hereinafter referred to as “full-overlap collision”), the shock absorbing members are requested to be sequentially destroyed along an input direction of a collision load and to thereby stably absorb energy.

In addition, when the shock absorbing member breaks (falls) during the sequential destruction and an uncrushed portion is left, the shock absorbing member may not stably absorb energy. Thus, the shock absorbing member is requested not to be broken such that the whole shock absorbing member is crushed even when a collision occurs from an oblique front (in an obliquely right direction or an obliquely left direction) in a planar view (hereinafter referred to as “oblique collision”).

Patent Literature 1 discloses one contrivance for avoiding breakage of a shock absorbing member in a collision. In Patent Literature 1, a base end side of a shock absorbing member (20) is reinforced by a reinforcement portion (36).

In an oblique collision, a collision load in a direction inclined with respect to left and right shock absorbing members is input. Thus, in an oblique collision, one shock absorbing member, particularly, a portion on a vehicle-width-direction inner side intensively receives a collision load compared to a portion on a vehicle-width-direction outer side.

However, the vehicle-width-direction inner side of a part including the reinforcement portion (36) of the shock absorbing member (20) has a straight shape in a front-rear direction. Consequently, the shock absorbing member (20) of Patent Literature 1 is weak in a bending moment and is not suitable for an oblique collision. Thus, there is room for improvement.

### CITATION LIST

### Patent Literature

Patent Literature 1: Japanese Patent Laid-Open No. 2010-195068

### SUMMARY OF INVENTION

### Technical Problem

An object of the disclosed technique is to provide a shock absorbing structure for a vehicle that may effectively manage various collisions.

### Solution to Problem

The disclosed technique relates to a shock absorbing structure for a vehicle, the shock absorbing structure including: a pair of left and right vehicle-body frame members disposed at an interval in a vehicle width direction; a pair of left and right shock absorbing members extending in a front-rear direction of the vehicle and respectively having rear ends connected with the respective vehicle-body frame members; and a bumper beam connecting front ends of the respective shock absorbing members together in the vehicle width direction.

The shock absorbing member is formed of a fiber-reinforced resin into an open cross section shape in which a vehicle-width-direction outer side is open and includes: an upper wall portion; a lower wall portion opposite to the upper wall portion in an up-down direction; a side wall portion connecting together inner edge portions of the upper wall portion and of the lower wall portion on a vehicle-width-direction inner side and having a recess recessed toward the vehicle-width-direction outer side in an intermediate portion in the up-down direction; an upper flange portion extending upward from an outer edge portion of the upper wall portion on the vehicle-width-direction outer side; and a lower flange portion extending downward from an outer edge portion of the lower wall portion on the vehicle-width-direction outer side.

The outer edge portion of each of the upper wall portion and the lower wall portion extends in parallel with the front-rear direction of the vehicle, the inner edge portion of each of the upper wall portion and the lower wall portion extends in an inclined manner such that a rear side of the inner edge portion is positioned on the vehicle-width-direction inner side of a front side of the inner edge portion, and a width of each of the upper wall portion and the lower wall portion is wider on a rear side than a front side.

Step portions are formed respectively in the upper wall portion and the lower wall portion, and the step portions make an interval between the upper wall portion and the lower wall portion become narrower on the vehicle-width-direction inner side than the vehicle-width-direction outer side.

In such a shock absorbing structure for a vehicle, the step portion increases ridges of the shock absorbing member. Consequently, it becomes possible to increase an energy absorption amount of the shock absorbing member. Energy absorption for various collisions such as a full-overlap collision and an oblique collision may be enhanced.

In the shock absorbing structure for a vehicle, a bottom portion of the recess may be positioned in a generally intermediate portion of the shock absorbing member in the vehicle width direction.

In such a shock absorbing structure for a vehicle, the recess, particularly, the bottom portion thereof effectively functions in a collision, and the energy absorption by the shock absorbing member is enhanced. Consequently, various collisions may effectively be managed.

The step portions may be formed in positions generally matching the bottom portion of the recess in the vehicle width direction.

Accordingly, structurally reinforced parts are collected to a generally intermediate position of the shock absorbing member in the vehicle width direction. Consequently, the energy absorption by the shock absorbing member may further be enhanced.

The inner edge portion may be inclined at an inclination angle of 5° or greater to 20° or smaller with respect to the front-rear direction of the vehicle.

The inclination angle of the inner edge portion is set to 5° or greater, and the shock absorbing member may thereby be made less likely to fall particularly in an oblique collision. Consequently, the energy absorption amount in an oblique collision may be enhanced.

Further, the inclination angle of the inner edge portion is set to 20° or smaller, and the shock absorbing member may thereby be made less likely to fall in a full-overlap collision. Further, the shock absorbing member may be inhibited from becoming heavy.

Note that the inclination angle of the inner edge portion is more desirably set to 5° or greater to 10° or smaller.

The bumper beam may have a curved shape in which a central portion in the vehicle width direction is positioned in front of both end portions, the shock absorbing member may have: a rear bent portion connected with the vehicle-body frame member; and a front bent portion connected with the bumper beam, the rear bent portion may be formed on the vehicle-width-direction outer side of the side wall portion, and the front bent portion may be formed on the vehicle-width-direction inner side of the side wall portion.

Accordingly, thanks to the fact that a transverse cross section of the shock absorbing member is larger on a front side than a rear side, a wide mounting area of the shock absorbing member can be secured with respect to the vehicle-body frame member, and easiness of press molding of the shock absorbing member can also be enhanced.

### Advantageous Effect of Invention

In the disclosed technique, various collisions may effectively be managed.

### BRIEF DESCRIPTION OF DRAWINGS

FIG. 1 is an external perspective view illustrating a vehicle-body structure in a front portion of a vehicle.

FIG. 2 is a left side view illustrating a vehicle left side of a front portion of a suspension support structure body and a shock absorbing structure body.

FIG. 3 is a plan view of the front portion of the vehicle, in which the left half illustrates an A-A arrow cross section in FIG. 2.

FIG. 4 is an external perspective view illustrating the shock absorbing structure body as seen from an oblique front.

FIG. 5 is an external perspective view illustrating the shock absorbing structure body as seen from an oblique rear.

FIG. 6 is an external perspective view of a shock absorbing member provided on a left side of the vehicle.

FIG. 7 is an enlarged cross-sectional view taken along line B-B in FIG. 3.

FIG. 8 is an enlarged arrow cross-sectional view taken along line B-B in FIG. 3.

FIG. 9 is an enlarged arrow cross-sectional view taken along line C-C in FIG. 3.

### DESCRIPTION OF EMBODIMENT

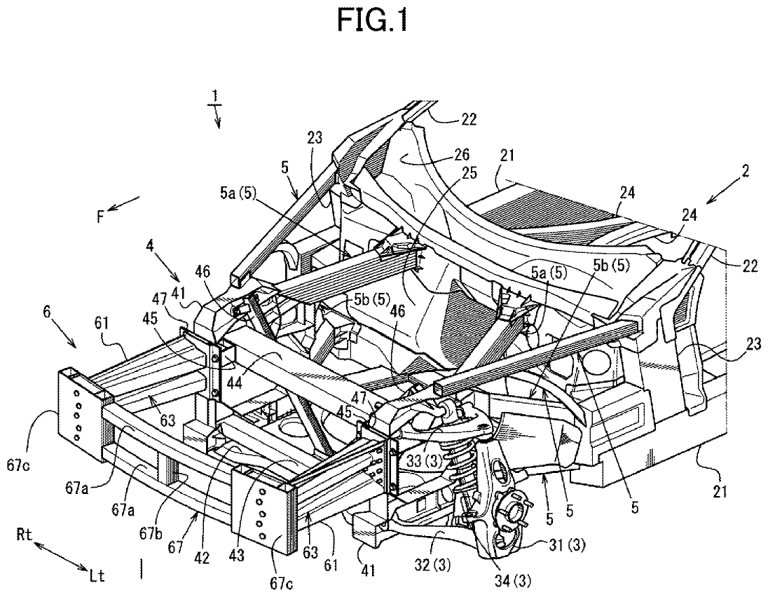

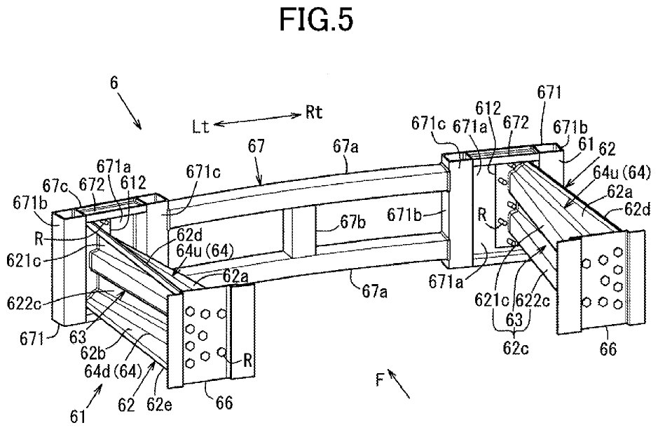

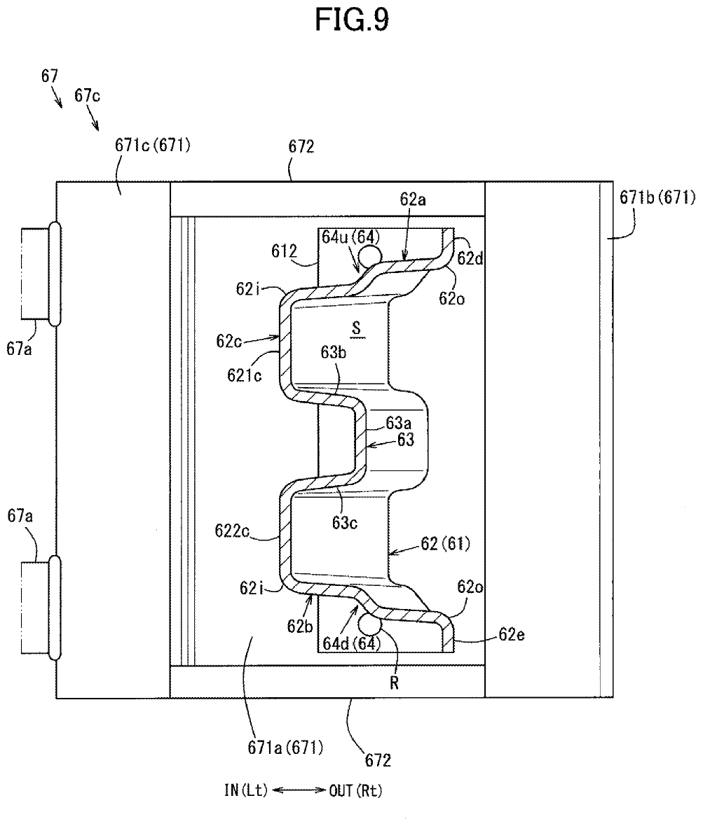

One embodiment of the disclosed technique will hereinafter be described with reference to drawings. A vehicle body of a vehicle 1 of this embodiment is configured by connecting together plural frames made of an aluminum alloy and molded by extrusion molding. That is, the vehicle body of the vehicle 1 is a so-called space frame structure. Such a vehicle body of the vehicle 1 will be described by using FIG. 1 to FIG. 9.

In order to make illustration clear, in FIG. 1, illustration of a front suspension 3 present on a right side of the vehicle 1 is omitted. Further, in each of the drawings, an arrow F indicates a vehicle front (a front of the vehicle 1). An arrow Rt indicates a vehicle right side (a right side of the vehicle 1). An arrow Lt indicates a vehicle left side (a left side of the vehicle 1).

An arrow OUT indicates a vehicle-width-direction outer side (an outward side of the vehicle 1 in a left-right direction). An arrow IN indicates a vehicle-width-direction inner side (an inward side of the vehicle 1 in the left-right direction). Directions such as front, rear, left, and right used in descriptions are based on the vehicle 1 as a reference.

As illustrated in FIG. 1, the vehicle body of the vehicle 1 includes a vehicle cabin portion 2 for occupants to get in, a suspension support structure body 4, plural frame members 5, and a shock absorbing structure body 6 absorbing a collision load from the vehicle front.

In the vehicle 1, front suspensions 3 are disposed in front of the vehicle cabin portion 2. The suspension support structure body 4 supports the front suspensions 3. The plural frame members 5 connect the vehicle cabin portion 2 with the suspension support structure body 4. The shock absorbing structure body 6 is connected with a front end of the suspension support structure body 4.

As illustrated in FIG. 1, the vehicle cabin portion 2 includes a pair of left and right side sills 21, a pair of left and right front pillars 22, a pair of left and right hinge pillars 23, a center tunnel frame 24, a dash panel 25, and a dash upper panel 26.

The pair of side sills 21 extend in a front-rear direction of the vehicle 1 in positions at a predetermined interval in a vehicle width direction. The pair of front pillars 22 are placed above the side sills 21. The pair of hinge pillars 23 connect front ends of the side sills 21 with front ends of the front pillars 22 in an up-down direction. The center tunnel frame 24 extends in the front-rear direction in a generally central position in the vehicle width direction. The dash panel 25 and the dash upper panel 26 connect the left and right hinge pillars 23 together in the vehicle width direction and configure a partition wall partitioning inside and outside of the vehicle cabin.

As illustrated in FIG. 1, the front suspension 3 is a double wishbone suspension structure. The front suspension 3 is configured with a knuckle 31, a lower arm 32, an upper arm 33, and an expandable front suspension damper 34.

The knuckle 31 rotatably supports a front wheel of the vehicle 1. A vehicle-width-direction outer side of the lower arm 32 is connected with a lower portion of the knuckle 31, and a vehicle-width-direction inner side of the lower arm 32 is connected with the vehicle body. A vehicle-width-direction outer side of the upper arm 33 is connected with an upper portion of the knuckle 31, and a vehicle-width-direction inner side of the upper arm 33 is connected with the vehicle body. An upper end of the front suspension damper 34 is connected with the vehicle body, and a lower end of the front suspension damper 34 is connected with the lower arm 32.

As illustrated in FIG. 1, the suspension support structure body 4 is configured with a pair of left and right suspension support members 41, a suspension cross member 42, a lower cross member 43, an upper cross member 44, a pair of left and right box members 45, and a pair of left and right tilt frames 46.

The pair of suspension support members 41 are disposed at a predetermined interval in the vehicle width direction and support the front suspensions 3. The suspension cross member 42 connects the vicinities of lower ends of the left and right suspension support members 41 together. The lower cross member 43 connects lower portions of the left and right suspension support members 41 together in positions slightly above the suspension cross member 42. The upper cross member 44 connects upper portions of the left and right suspension support members 41 together. The pair of box members 45 are joined to the upper cross member 44. The pair of tilt frames 46 connect the suspension support members 41 and the suspension cross member 42 together.

As illustrated in FIG. 1, the shock absorbing structure body 6 is configured with a pair of left and right shock absorbing members 61 connected with front ends of the left and right suspension support members 41 and a front bumper beam 67 connecting the front ends of the shock absorbing members 61 together in the vehicle width direction.

As illustrated in FIG. 1 to FIG. 3, the pair of suspension support members 41 are members made of die-cast aluminum and having a predetermined thickness in the vehicle width direction and are configured in a frame shape in a side view. The pair of suspension support members 41 have a function of swingably supporting the front suspensions 3.

Further, in a front surface collision of the vehicle 1, a collision load is input from the front bumper beam 67 and transmitted to a rear of the vehicle body via the shock absorbing members 61. The suspension support members 41 and the above-described plural frame members 5 have a function of transmitting the collision load to a further rear (vehicle cabin portion 2) of the vehicle body.

As illustrated in FIG. 1, the frame members 5 include inner center frame members 5a and outer center frame members 5b, which respectively form left-and-right pairs. Among the frame members 5, in particular, those inner center frame members 5a and the outer center frame members 5b provide a function of transmitting the collision load to the rear of the vehicle body.

The inner center frame member 5a linearly extends to the vehicle-width-direction inner side and upward toward a rear side. The inner center frame member 5a connects a rear wall of the upper portion of the suspension support member 41 with a front end of the center tunnel frame 24. Further, the inner center frame member 5a transmits the collision load transmitted from the shock absorbing member 61 to the rear of the vehicle body to the center tunnel frame 24 via the suspension support member 41.

The outer center frame member 5b linearly extends to the vehicle-width-direction outer side and downward toward the rear side. The outer center frame member 5b connects a rear wall of the suspension support member 41 with the hinge pillar 23 below the inner center frame member 5a. Further, the outer center frame member 5b transmits the collision load transmitted from the shock absorbing member 61 to the rear of the vehicle body to the hinge pillar 23 via the suspension support member 41.

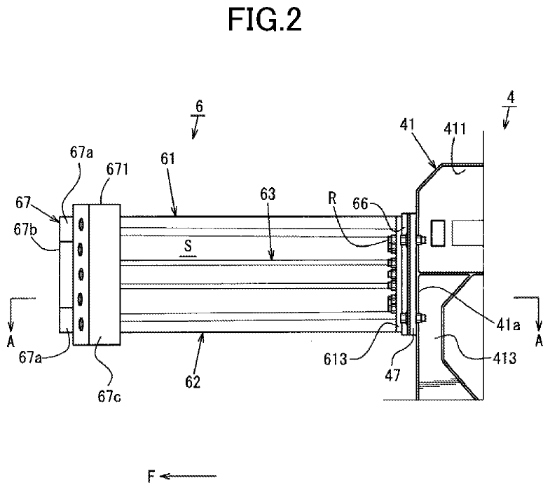

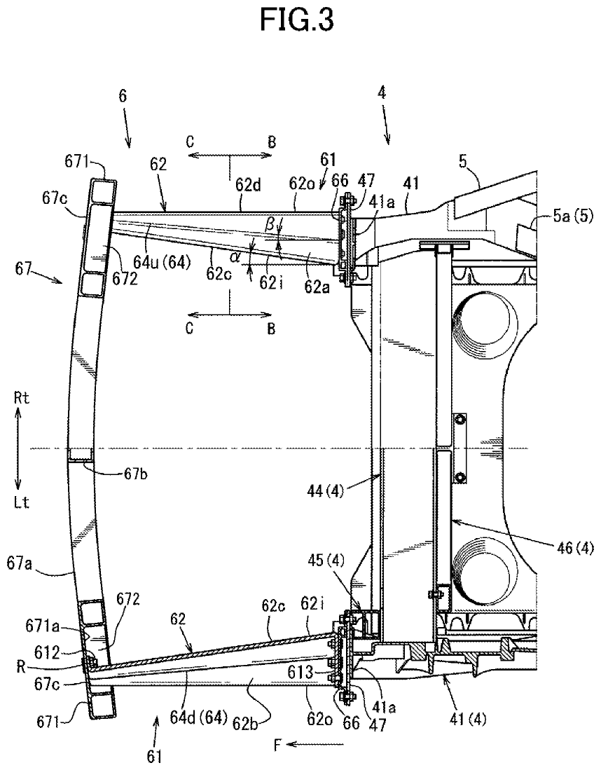

As illustrated in FIG. 2, an upper portion of a front surface of the suspension support member 41 is configured as a rear end connected portion 41a. The shock absorbing member 61 (a rear bent portion 613 described later (see FIG. 2 and FIG. 3)) of the shock absorbing structure body 6 is connected with the rear end connected portion 41a.

As illustrated in FIG. 2 and FIG. 3, a mounting plate 47 is joined to the rear end connected portion 41a. The mounting plate 47 is formed into a generally flat plate shape longer in the vehicle width direction (wider width) than the rear end connected portion 41a.

As described above, the shock absorbing structure body 6 is configured with the pair of left and right shock absorbing members 61 and the front bumper beam 67. The shock absorbing member 61 is made of a fiber-reinforced resin. For example, the shock absorbing member 61 is formed of a carbon-fiber reinforced plastic.

As illustrated in FIG. 3 to FIG. 6, the shock absorbing member 61 has a shock absorbing body 62 extending in the front-rear direction, a front bent portion 612 in a generally flat plate shape, and the rear bent portion 613 in a general frat plate shape. The shock absorbing member 61 is integrally formed by resin molding.

The front bent portion 612 is provided to extend from a front end of the shock absorbing body 62 to the vehicle-width-direction inner side and is connected with a rear surface of the front bumper beam 67. The rear bent portion 613 is provided to extend from a rear end of the shock absorbing body 62 to the vehicle-width-direction outer side and is connected with a front surface of the mounting plate 47 on the vehicle body side via a set plate 66.

As illustrated in FIG. 3, in a planar view, in other words, when seen in the up-down direction, the shock absorbing body 62 has an edge portion positioned on the vehicle-width-direction outer side (outer edge portion 62o) and an edge portion positioned on the vehicle-width-direction inner side (inner edge portion 62i).

The outer edge portions 62o, 62o (the respective outer edge portions 62o of an upper wall portion 62a and a lower wall portions 62b, which will be described later) linearly extend in parallel with the front-rear direction. The inner edge portions 62i, 62i (the respective inner edge portions 62i of the upper wall portion 62a and the lower wall portion 62b, which will be described later) linearly extend in an inclined manner such that rear sides are positioned on the vehicle-width-direction inner side of front sides.

Specifically, an inclination angle α (see FIG. 3) of each of the inner edge portions 62i in the upper wall portion 62a and the lower wall portion 62b is set to 5° or greater to 20° or smaller with respect to the front-rear direction and more desirably to 6° or greater to 10° or smaller (8° in this embodiment).

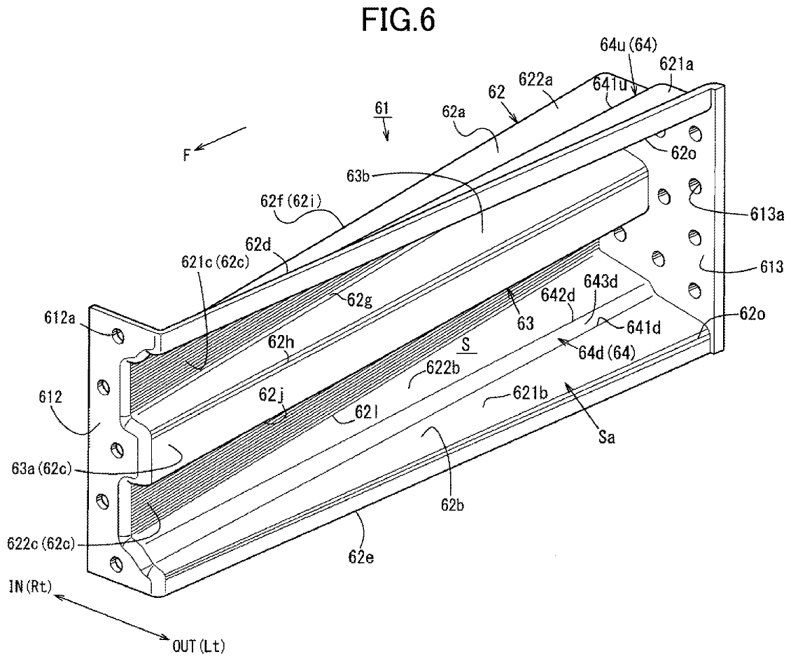

Accordingly, as illustrated in FIG. 6, the width of the shock absorbing body 62 gradually becomes wider from the front end toward the rear end. From the front end toward the rear end, the area of a transverse cross section of the shock absorbing body 62 gradually becomes larger.

In addition, as illustrated in FIG. 6 to FIG. 9, the shock absorbing body 62 has the same shape in which a vehicle-width-direction outer side is open (open cross section shape) throughout the whole length of the shock absorbing body 62 (except the front end having the front bent portion 612 and the rear end having the rear bent portion 613).

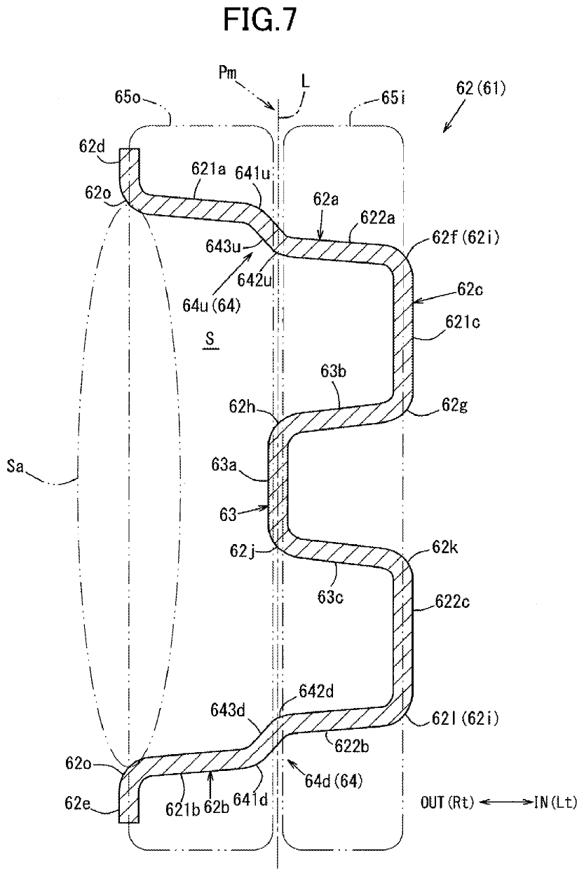

As illustrated in FIG. 7 to FIG. 9, the shock absorbing body 62 includes the upper wall portion 62a, the lower wall portion 62b, a side wall portion 62c, an upper flange portion 62d, and a lower flange portion 62e.

The upper wall portion 62a and the lower wall portion 62b extend in the vehicle width direction in a state where those are opposite to each other in the up-down direction. The side wall portion 62c connects together the respective inner edge portions 62i, 62i of those upper wall portion 62a and lower wall portion 62b. The upper flange portion 62d extends upward from the outer edge portion 62o of the upper wall portion 62a. The lower flange portion 62e extends downward from the outer edge portion 62o of the lower wall portion 62b.

Accordingly, as illustrated in FIG. 6 and FIG. 7, the shock absorbing body 62 has a space S extending in the front-rear direction in an internal portion of the shock absorbing body 62 and has an opening Sa making the space S open to the vehicle-width-direction outer side. Note that a wall thickness of the shock absorbing body 62 is generally constant.

The side wall portion 62c configures a wall surface of the shock absorbing body 62, the wall surface being positioned on the vehicle-width-direction inner side. The side wall portion 62c has a recess recessed toward the vehicle-width-direction outer side in an intermediate portion of the side wall portion 62c in the up-down direction. Further, the side wall portion 62c has a side wall upper portion 621c continuous with an upper side of the recess 63 and a side wall lower portion 622c continuous with a lower side.

The recess 63 has a recess bottom portion 63a configuring a bottom portion of the recess 63, a recess wall upper portion 63b, and a recess wall lower portion 63c (see FIG. 7 to FIG. 9) and is integrally formed. The recess 63 has a transverse cross section in a generally transverse U shape.

The recess bottom portion 63a has a strip shape facing in the left-right direction and is positioned on the vehicle-width-direction outermost side in the recess 63. The recess wall upper portion 63b has a strip shape facing in the up-down direction and connects an upper end of the recess bottom portion 63a with a lower end of the side wall upper portion 621c. The recess wall lower portion 63c has a strip shape opposite to the recess wall upper portion 63b in the up-down direction and connects a lower end of the recess bottom portion 63a with an upper end of the side wall lower portion 622c.

Note that in consideration of the draft angle of a die in resin molding, the upper wall portion 62a and the recess wall lower portion 63c are inclined slightly upward toward the vehicle-width-direction outer side. The lower wall portion 62b and the recess wall upper portion 63b are inclined slightly downward toward the vehicle-width-direction outer side. That is, the shock absorbing member 61 is formed such that an interval of the space S in the up-down direction gradually becomes longer toward the side of the opening Sa (from the vehicle-width-direction inner side toward the vehicle-width-direction outer side).

The side wall upper portion 621c and the side wall lower portion 622c have strip shapes facing in the left-right direction. The side wall upper portion 621c and the side wall lower portion 622c are linearly arranged in the up-down direction and disposed such that the positions of those in the vehicle width direction match each other. The recess bottom portion 63a is disposed in an intermediate position Pm (see FIG. 7) of the shock absorbing body 62 in the vehicle width direction so as to alternate with the side wall upper portion 621c and the side wall lower portion 622 in the vehicle width direction.

As illustrated in FIG. 7, each of the upper wall portion 62a and the lower wall portion 62b is formed into a stepped shape, and a step portion 64 is formed. An upper step portion 64u is formed in the upper wall portion 62a. A lower step portion 64d is formed in the lower wall portion 62b.

The step portions 64 make the interval between the upper wall portion 62a and the lower wall portion 62b become narrower on the vehicle-width-direction inner side than the vehicle-width-direction outer side. That is, the interval between the respective inner edge portions 62i, 62i of the upper wall portion 62a and the lower wall portion 62b (the length of the side wall portion 62c in the up-down direction) is narrower than the interval between the respective outer edge portions 62o, 62o of the upper wall portion 62a and the lower wall portion 62b (the length of the opening Sa in the up-down direction).

Specifically, as illustrated in FIG. 7, when the shock absorbing body 62 is seen from a transverse cross section direction, the upper wall portion 62a has an outer wall portion 621a and an inner wall portion 622a. The outer wall portion 621a corresponds to a part in the upper wall portion 62a, the part being positioned on the vehicle-width-direction outer side with respect to the upper step portion 64u (referred to as “outer part 65o”). The inner wall portion 622a corresponds to a part in the upper wall portion 62a, the part being positioned on the vehicle-width-direction inner side with respect to the upper step portion 64u (referred to as “inner part 65i”).

The upper step portion 64u is positioned in a position between the outer wall portion 621a and the inner wall portion 622a (in this example, the intermediate position Pm in the vehicle width direction) and offsets the inner wall portion 622a so as to make the inner wall portion 622a closer to the recess 63 side than the outer wall portion 621a.

The upper step portion 64u has an outer ridge 641u corresponding to a borderline with the outer wall portion 621a, an inner ridge 642u corresponding to a borderline with the inner wall portion 622a, and a step surface portion 643u continuous with those ridges 641u and 642u. The outer ridge 641u protrudes obliquely upward to the vehicle-width-direction inner side. The inner ridge 642u protrudes obliquely downward to the vehicle-width-direction outer side. The step surface portion 643u is inclined upward toward the vehicle-width-direction outer side.

Similarly, the lower wall portion 62b has an outer wall portion 621b and an inner wall portion 622b. The lower step portion 64d is positioned in a position between the outer wall portion 621b and the inner wall portion 622b and offsets the inner wall portion 622b so as to make the inner wall portion 622b closer to the recess 63 side than the outer wall portion 621b.

The lower step portion 64d has an outer ridge 641d corresponding to a borderline with the outer wall portion 621b, an inner ridge 642d corresponding to a borderline with the inner wall portion 622b, and a step surface portion 643d continuous with those ridges 641d and 642d. The outer ridge 641d protrudes obliquely downward to the vehicle-width-direction inner side. The inner ridge 642d protrudes obliquely upward to the vehicle-width-direction outer side. The step surface portion 643d is inclined downward toward the vehicle-width-direction outer side.

As illustrated in FIG. 3 and FIG. 7, each of the step portions 64u and 64d linearly extends in the front-rear direction, in other words, a longitudinal direction of the shock absorbing member 61 and is inclined to the vehicle-width-direction inner side toward the rear (see particularly FIG. 3).

In other words, in a case where an inclination angle of the inner edge portion 62i inclined with respect to the front-rear direction in a planar view is set as α, each of the step portions 64u and 64d is inclined at an inclination angle β that corresponds to generally half the inclination angle α. In this embodiment, the inclination angle β is set to 4°.

As illustrated in FIG. 7, the recess bottom portion 63a is formed in a position generally matching the step portions 64 in the vehicle width direction.

Specifically, each of the upper step portion 64u and the lower step portion 64d has a certain width in the vehicle width direction. Thus, on the assumption of a line L partially matching the recess bottom portion 63a and extending in the up-down direction, the positional relationship is set such that the line L passes through a portion between the upper step portion 64u and the lower step portion 64d.

In this embodiment, in particular, the line L is set to pass through the vehicle-width inner ridges 642u and 642d or the vicinities thereof in the step portions 64 (the upper step portion 64u and the lower step portion 64d).

The recess bottom portion 63a is disposed on the vehicle-width-direction inner side of the outer part 65o. The vehicle-width-direction outer side of the outer part 65o is open. That is, the outer part 65o is configured with the upper flange portion 62d, the outer wall portion 621a, the step portions 64 (64u and 64d), the recess bottom portion 63a, the lower flange portion 62e, and the outer wall portion 621b.

The recess bottom portion 63a is disposed on the vehicle-width-direction outer side of the inner part 65i. The side wall upper portion 621c and the side wall lower portion 622c are disposed on the vehicle-width-direction inner side of the inner part 65i. That is, the inner part 65i is configured with the step portions 64 (64u and 64d), the inner wall portion 622a, the side wall portion 62c, and the inner wall portion 622b.

That is, the total cross-sectional area of the transverse cross section of the inner part 65i is formed larger than the total cross-sectional area of the transverse cross section of the outer part 65o. Further, the inner part 65i is formed to have a greater number of ridges (for example, 62f, 62g, 62h, 62j, and 62k) than the outer part 65o.

Each of reference characters 62f, 62g, 62h, 62j, 62k, and 62l in FIG. 7 denotes a ridge portion formed in the inner part 65i. The ridge 62f is formed in a bent portion of a boundary between the upper wall portion 62a and the side wall upper portion 621c; the ridge 62g in a bent portion of a boundary between the side wall upper portion 621c and recess wall upper portion 63b; the ridge 62h in a bent portion of a boundary between the recess wall upper portion 63b and the recess bottom portion 63a; the ridge 62j in a bent portion of a boundary between the recess bottom portion 63a and the recess wall lower portion 63c; the ridge 62k in a bent portion of a boundary between the recess wall lower portion 63c and the side wall lower portion 622c; and the ridge 62l in a bent portion of a boundary between the side wall lower portion 622c and the lower wall portion 62b.

Each of the bent portions in which those ridges 62f, 62g, 62h, 62j, 62k, and 62l are positioned has a bent shape having a curved cross section. The curvatures of the bent portions are set as small as possible. Accordingly, strength against “breakage” of the shock absorbing body 62 in an oblique collision is enhanced.

In an oblique collision, a load (collision load) input to the shock absorbing body 62 is more largely exerted on the inner part 65i than the outer part 65o. In addition, in an oblique collision, a collision occurs to the front bumper beam 67 in an inclined direction with respect to the front-rear direction. Thus, the collision load is usually input to one shock absorbing member 61 between the left and right shock absorbing members 61, 61.

Thus, the rigidity of the inner part 65i that is likely to receive the collision load input in an oblique collision is reinforced compared to the outer part 65o as described above. In addition, as illustrated in FIG. 3, an extending direction of the inner edge portion 62i is inclined so as to become close to an input direction of the collision load. Accordingly, the shock absorbing body 62 is formed into a shape suitable for an oblique collision.

Consequently, in an oblique collision, the inner part 65i of one shock absorbing member 61, to which the collision load is input, between the left and right shock absorbing members 61, 61 chiefly receives the collision load. As a result, the shock absorbing member 61 does not break in the middle of an oblique collision thereof and may thereby stably absorb energy.

Meanwhile, in a case of a full-overlap collision, the left and right shock absorbing members 61, 61 usually cooperatively receive a collision load input from a direct front of the front bumper beam 67.

Thus, the upper flange portion 62d and the lower flange portion 62e are disposed on the vehicle-width-direction outer side of the outer part 65o, the step portions 64 (64u and 64d) and the recess bottom portion 63a are disposed on the vehicle-width-direction inner side, and rigidity is thereby reinforced. In addition, each of the outer edge portions 62o is disposed to extend in parallel with the front-rear direction.

Consequently, in a full-overlap collision, the outer parts 65o of both of the left and right shock absorbing members 61, 61 chiefly receive the collision load. The shock absorbing member 61 is in a shape also suitable for a full-overlap collision.

As a result, the shock absorbing member 61 does not break in the middle of a full-overlap collision thereof. The left and right shock absorbing members 61, 61 may cooperatively absorb energy stably.

Further, the front bent portion 612 is bent to the vehicle-width-direction inner side with respect to the side wall portion 62c at the front end of the shock absorbing body 62.

Specifically, the front bent portion 612 is formed in a whole area of the shock absorbing body 62 in the up-down direction, the whole area including the upper flange portion 62d and the lower flange portion 62e. Further, the front bent portion 612 is formed to slightly protrude to the vehicle-width-direction inner side of the side wall portion 62c.

The front bumper beam 67 has a curved shape in which a central portion in the vehicle width direction is positioned in front of both end portions (see FIG. 3). Thus, the front bent portion 612 connected with the front bumper beam 67 is formed to be positioned in front toward the vehicle-width-direction inner side, corresponding to the curved shape of the front bumper beam 67.

As illustrated in FIG. 6, plural insertion holes 612a are formed to pass through the front bent portion 612. The front bumper beam 67 is mounted on the front bent portion 612 by rivets R inserted into those insertion holes 612a. Note that the front bumper beam 67 may be mounted by fastening by bolts or welding.

The rear bent portion 613 is bent to the vehicle-width-direction outer side with respect to the side wall portion 62c at the rear end of the shock absorbing body 62.

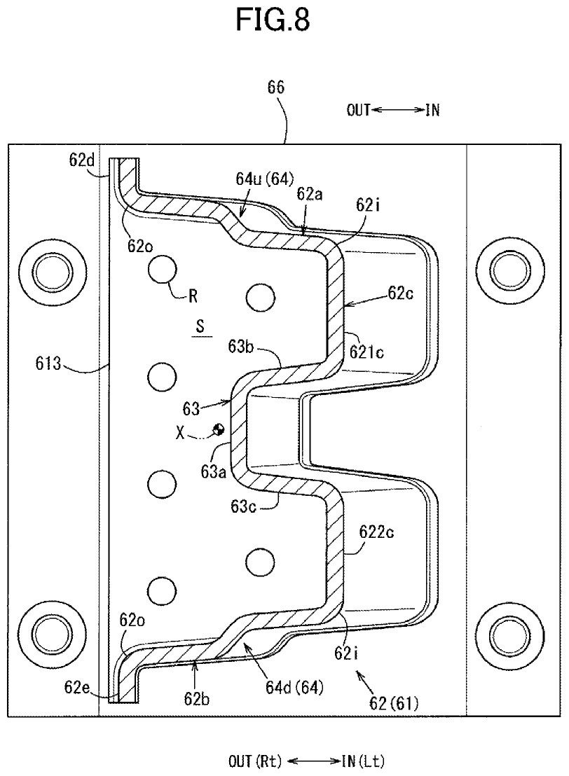

Specifically, the rear bent portion 613 is formed in a size covering a whole range of a rear end surface of the shock absorbing body 62. The rear bent portion 613 is formed to cross an axial center X (see FIG. 8) of the shock absorbing body 62.

As described above, the front bent portion 612 and the rear bent portion 613 are disposed in the opposite directions from each other in the vehicle width direction across the side wall portion 62c. As illustrated in FIG. 6, plural insertion holes 613a are formed to pass through the rear bent portion 613. The set plate 66 is mounted on the rear bent portion 613 by the rivets R inserted into those insertion holes 613a. Note that the set plate 66 may be mounted by fastening by bolts or welding.

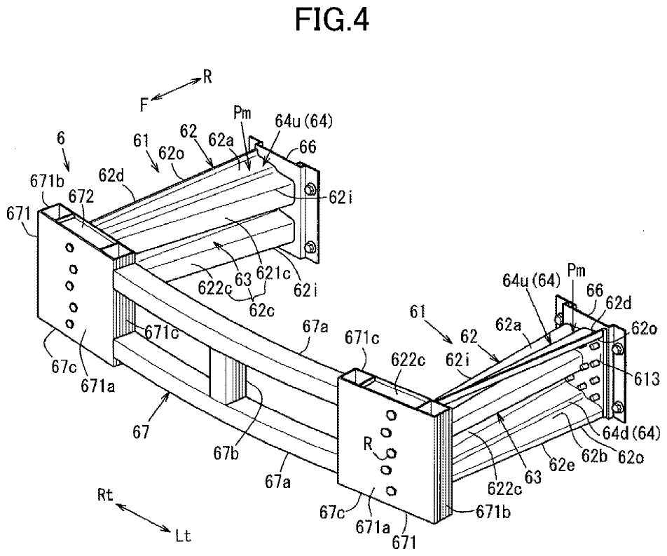

As illustrated in FIG. 4, the set plate 66 is an extrusion molded component of an aluminum alloy. The set plate 66 has a generally hat-shaped cross section and is formed to have generally the same size as the mounting plate 47.

Flange portions in the set plate 66 on the vehicle-width-direction outer side and on the vehicle-width-direction inner side are each fastened and fixed to the front surface of the mounting plate 47. Then, the rear bent portion 613 is mounted on a bearing surface of the set plate 66, the bearing surface protruding forward.

As illustrated in FIG. 3 to FIG. 5, the front bumper beam 67 is configured with a pair of upper and lower body frames 67a, 67a, a reinforcement frame 67b, and member mounting portions 67c.

The pair of body frames 67a, 67a extend in the vehicle width direction at an interval in the up-down direction. The reinforcement frame 67b connects the pair of body frames 67a, 67a at a general center of those in the vehicle width direction. The member mounting portions 67c are joined to both ends of each of the body frames 67a, and the front ends of the shock absorbing members 61 are mounted on the member mounting portions 67c.

Each of the body frames 67a is an extrusion molded component of an aluminum alloy. Each of the body frames 67a is formed with a pipe having a rectangular cross section and is curved. [0098]

The reinforcement frame 67b is formed with a pipe having a rectangular cross section and is an extrusion molded component of an aluminum alloy. The reinforcement frame 67b is joined to a lower surface of the upper body frame 67a and to an upper surface of the lower body frame 67a.

The member mounting portion 67c is configured with a mounting portion body 671 on which the shock absorbing member 61 is mounted and a pair of upper and lower reinforcement members 672 improving the rigidity of the mounting portion body 671.

The mounting portion body 671 is an extrusion molded component of an aluminum alloy. The mounting portion body 671 is integrally formed with a connected portion 671a in a generally flat plate shape on which the front bent portion 612 is mounted, an outer wall portion 671b projecting rearward from an edge of the connected portion 671a on the vehicle-width-direction outer side, and an inner wall portion 671c projecting rearward from an edge of the connected portion 671a on the vehicle-width-direction inner side.

The front bent portion 612 is mounted on a rear surface of the connected portion 671a. The front bent portion 612 is fixed by the rivets in a state where the front bent portion 612 abuts on the rear surface of the curved connected portion 671a.

The outer wall portion 671b and the inner wall portion 671c are formed into tubular shapes generally the same as the body frame 67a.

In a shock absorbing structure described in this embodiment, the step portions 64 (64u and 64d) are formed in the upper wall portion 62a and the lower wall portion 62b, and the following actions and effects may thereby be obtained.

That is, against a full-overlap collision, the left and right shock absorbing members 61 cooperate with each other, and mainly a portion on the vehicle-width-direction outer side (outer part 65o) in each of the left and right shock absorbing members 61 thereby absorbs energy without falling. Against an oblique collision, mainly a portion on the vehicle-width-direction inner side (inner part 65i) in the shock absorbing member 61, to which energy is input, between the left and right shock absorbing members 61 absorbs energy without falling.

In addition, the step portions 64 (64u and 64d) are formed in the upper wall portion 62a and the lower wall portion 62b, and the ridges 641u, 641d, 642u, and 642d may thereby be added to the shock absorbing member 61. Thus, an energy absorption amount of the shock absorbing member 61 may be increased.

Consequently, energy absorption for both of a full-overlap collision and an oblique collision may be enhanced.

Further, the recess bottom portion 63a of the recess 63 is disposed in the generally intermediate position Pm of the shock absorbing member 61 in the vehicle width direction, and the following actions and effects may thereby be obtained.

In a full-overlap collision, the left and right shock absorbing members 61 cooperatively receive the collision load. Thus, in a full-overlap collision, breakage of the shock absorbing member 61 may be inhibited.

Further, in an oblique collision, the collision load is received by one shock absorbing member 61 between the left and right shock absorbing members 61. Due to the relationship with the input direction of the collision load, the portion on the vehicle-width-direction inner side (inner part 65i) mainly receives the collision load.

As illustrated in FIG. 7, the recess bottom portion 63a is disposed in the generally intermediate position Pm, and the recess bottom portion 63a is thereby positioned on the vehicle-width-direction inner side of the outer part 65o and positioned on the vehicle-width-direction outer side of the inner part 65i.

Consequently, the recess 63 may be caused to effectively function for enhancement of the energy absorption for both of a full-overlap collision and an oblique collision.

In addition, the recess wall upper portion 63b and the recess wall lower portion 63c are disposed to cross a whole range of the inner part 65i. The recess 63 is provided which has a depth at which the recess bottom portion 63a is positioned in the generally intermediate position Pm. The area of the transverse cross section of the outer part 65o may be increased. Thus, the energy absorption for an oblique collision may further be enhanced.

Formability may be enhanced compared to forming the recess 63 more deeply than the generally intermediate position Pm.

The step portions 64 (64u and 64d) are formed in positions generally matching the recess bottom portion 63a in the vehicle width direction.

As a result, the recess bottom portion 63a and the step portions 64 may be disposed in the generally intermediate position Pm.

Accordingly, the ridges 641u, 641d, 642u, 642d, 62h, and 62j are collected to the generally intermediate position Pm. Consequently, the energy absorption for both of a full-overlap collision and an oblique collision may further be enhanced.

Further, the inclination angle α of the inner edge portion 62i is set to 5° or greater to 20° or smaller with respect to the front-rear direction, for example, to 8°.

The inclination angle of the inner edge portion 62i is set to 5° or greater, and the shock absorbing member 61 may thereby be made less likely to fall in an oblique collision. The energy absorption amount in an oblique collision may be enhanced.

The inclination angle α of the inner edge portion 62i is set to 20° or smaller, and lowering of the energy absorption of the shock absorbing member 61 in a full-overlap collision may thereby be inhibited. Further, the weight of the shock absorbing member 61 may be prevented from becoming large.

Further, the rear bent portion 613 is formed on the vehicle-width-direction outer side of the side wall portion 62c, and the front bent portion 612 is formed on the vehicle-width-direction inner side of the side wall portion 62c.

Accordingly, thanks to the fact that the transverse cross section of the shock absorbing member 61 is larger on the front side than the rear side, a wide mounting area of the rear bent portion 613 can be secured.

Specifically, because the shock absorbing member 61 is in an open cross section shape in which the vehicle-width-direction outer side is open, the rear bent portion 613 is formed on the vehicle-width-direction outer side of the side wall portion 62c and may thereby be formed to close a rear end surface of the shock absorbing member 61.

Because the width of the rear side of the shock absorbing member 61 is wide, the rear side may be formed larger than the front side.

Thus, the rear bent portion 613 is formed to close a whole range of the large rear end surface of the shock absorbing member 61, the recess 63 is formed to have the depth at which the recess bottom portion 63a is positioned in the generally intermediate position Pm, and the large rear bent portion 613 may thereby be formed at a rear end of the shock absorbing member 61.

Consequently, the rear bent portion 613 may be provided with plural insertion holes 613a. A wide mounting area may be secured.

In addition, the recess 63 is formed to have the depth at which the recess bottom portion 63a corresponds to the generally intermediate position Pm, and the rear bent portion 613 may thereby be provided so as to cross the axial center X. Accordingly, the rear bent portion 613 may firmly be mounted in a position adjacent to the axial center X.

Further, the front bent portion 612 is formed on a generally opposite side from the rear bent portion 613 with respect to the side wall portion 62c, and formability of the shock absorbing member 61 may thereby be secured.

For example, in a case where the front bent portion 612 is formed on the same side as the rear bent portion 613, the front bent portion 612 is mounted on the curved front bumper beam 67 and thus becomes a state of being warped rearward.

In this case, between a pair of dies for molding the shock absorbing member 61, the die on the side on which the front bent portion 612 and the rear bent portion 613 protrude may not obtain the draft angle, and a molded component may not smoothly be pulled out.

On the other hand, when the front bent portion 612 is formed on the vehicle-width-direction inner side, the front bent portion 612 may appropriately be mounted on the curved front bumper beam 67, the draft angles may be obtained for both of the dies, and formability may thus be secured.

The disclosed technique is not limited to the above-described embodiment. The disclosed technique may be applied to various embodiments.

For example, in the above-described embodiment, a description is made about the shock absorbing structure on the front side of the vehicle body; however, the disclosed technique may be applied to a shock absorbing structure on the rear side of the vehicle body. The suspension support member 41 may be configured with a front side frame or rear side frame extending in the front-rear direction.

The fiber-reinforced resin is not limited to carbon fiber resins. For example, other fiber-reinforced resins such as glass fiber and metal fiber may be used.

### REFERENCE SIGNS LIST

1 vehicle
41 suspension support member (vehicle-body frame member)
61 shock absorbing member
62a upper wall portion
62b lower wall portion
62c side wall portion
62d upper flange portion
62e lower flange portion
62o outer edge portion
62i inner edge portion
63 recess
63a recess bottom portion (bottom portion)
64 (64u, 64d) step portion
67 front bumper beam
612 front bent portion
613 rear bent portion

1. A shock absorbing structure for a vehicle, the shock absorbing structure comprising:
a pair of left and right vehicle-body frame members disposed at an interval in a vehicle width direction;
a pair of left and right shock absorbing members extending in a front-rear direction of the vehicle and respectively having rear ends connected with the respective vehicle-body frame members; and
a bumper beam connecting front ends of the respective shock absorbing members together in the vehicle width direction, wherein
the shock absorbing member is formed of a fiber-reinforced resin into an open cross section shape in which a vehicle-width-direction outer side is open and includes:
an upper wall portion;
a lower wall portion opposite to the upper wall portion in an up-down direction;
a side wall portion connecting together inner edge portions of the upper wall portion and of the lower wall portion on a vehicle-width-direction inner side and having a recess recessed toward the vehicle-width-direction outer side in an intermediate portion in the up-down direction;
an upper flange portion extending upward from an outer edge portion of the upper wall portion on the vehicle-width-direction outer side; and
a lower flange portion extending downward from an outer edge portion of the lower wall portion on the vehicle-width-direction outer side,
the outer edge portion of each of the upper wall portion and the lower wall portion extends in parallel with the front-rear direction of the vehicle, the inner edge portion of each of the upper wall portion and the lower wall portion extends in an inclined manner such that a rear side of the inner edge portion is positioned on the vehicle-width-direction inner side of a front side of the inner edge portion, and a width of each of the upper wall portion and the lower wall portion is wider on a rear side than a front side, and
step portions are formed respectively in the upper wall portion and the lower wall portion, and the step portions make an interval between the upper wall portion and the lower wall portion become narrower on the vehicle-width-direction inner side than the vehicle-width-direction outer side.

2. The shock absorbing structure for a vehicle according to claim 1, wherein
a bottom portion of the recess is positioned in a generally intermediate portion of the shock absorbing member in the vehicle width direction.

3. The shock absorbing structure for a vehicle according to claim 1, wherein
step portions are formed respectively in the upper wall portion and the lower wall portion, and the step portions make an interval between the upper wall portion and the lower wall portion become narrower on the vehicle-width-direction inner side than the vehicle-width-direction outer side.

4. The shock absorbing structure for a vehicle according to claim 1, wherein
the step portions are formed in positions generally matching a bottom portion of the recess in the vehicle width direction.

5. (canceled)

6. (canceled)

7. The shock absorbing structure for a vehicle according to claim 3, wherein
the step portions are formed in positions generally matching a bottom portion of the recess in the vehicle width direction.

8. The shock absorbing structure for a vehicle according to claim 1, wherein
the inner edge portion is inclined at an inclination angle of 5° or greater to 20° or smaller with respect to the front-rear direction of the vehicle.

9. The shock absorbing structure for a vehicle according to claim 2, wherein
the inner edge portion is inclined at an inclination angle of 5° or greater to 20° or smaller with respect to the front-rear direction of the vehicle.

10. The shock absorbing structure for a vehicle according to claim 3, wherein
the inner edge portion is inclined at an inclination angle of 5° or greater to 20° or smaller with respect to the front-rear direction of the vehicle.

11. The shock absorbing structure for a vehicle according to claim 4, wherein
the inner edge portion is inclined at an inclination angle of 5° or greater to 20° or smaller with respect to the front-rear direction of the vehicle.

12. The shock absorbing structure for a vehicle according to claim 7, wherein
the inner edge portion is inclined at an inclination angle of 5° or greater to 20° or smaller with respect to the front-rear direction of the vehicle.

13. The shock absorbing structure for a vehicle according to claim 1, wherein
the bumper beam has a curved shape in which a central portion in the vehicle width direction is positioned in front of both end portions,
the shock absorbing member has:
a rear bent portion connected with the vehicle-body frame member; and
a front bent portion connected with the bumper beam, and
the rear bent portion is formed on the vehicle-width-direction outer side of the side wall portion, and the front bent portion is formed on the vehicle-width-direction inner side of the side wall portion.

14. The shock absorbing structure for a vehicle according to claim 2, wherein
the bumper beam has a curved shape in which a central portion in the vehicle width direction is positioned in front of both end portions,
the shock absorbing member has:
a rear bent portion connected with the vehicle-body frame member; and
a front bent portion connected with the bumper beam, and
the rear bent portion is formed on the vehicle-width-direction outer side of the side wall portion, and the front bent portion is formed on the vehicle-width-direction inner side of the side wall portion.

15. The shock absorbing structure for a vehicle according to claim 3, wherein
the bumper beam has a curved shape in which a central portion in the vehicle width direction is positioned in front of both end portions,
the shock absorbing member has:
a rear bent portion connected with the vehicle-body frame member; and
a front bent portion connected with the bumper beam, and
the rear bent portion is formed on the vehicle-width-direction outer side of the side wall portion, and the front bent portion is formed on the vehicle-width-direction inner side of the side wall portion.

16. The shock absorbing structure for a vehicle according to claim 4, wherein
the bumper beam has a curved shape in which a central portion in the vehicle width direction is positioned in front of both end portions,
the shock absorbing member has:
a rear bent portion connected with the vehicle-body frame member; and
a front bent portion connected with the bumper beam, and
the rear bent portion is formed on the vehicle-width-direction outer side of the side wall portion, and the front bent portion is formed on the vehicle-width-direction inner side of the side wall portion.

17. The shock absorbing structure for a vehicle according to claim 7, wherein
the bumper beam has a curved shape in which a central portion in the vehicle width direction is positioned in front of both end portions,
the shock absorbing member has:
a rear bent portion connected with the vehicle-body frame member; and
a front bent portion connected with the bumper beam, and
the rear bent portion is formed on the vehicle-width-direction outer side of the side wall portion, and the front bent portion is formed on the vehicle-width-direction inner side of the side wall portion.

18. The shock absorbing structure for a vehicle according to claim 8, wherein
the bumper beam has a curved shape in which a central portion in the vehicle width direction is positioned in front of both end portions,
the shock absorbing member has:
a rear bent portion connected with the vehicle-body frame member; and
a front bent portion connected with the bumper beam, and
the rear bent portion is formed on the vehicle-width-direction outer side of the side wall portion, and the front bent portion is formed on the vehicle-width-direction inner side of the side wall portion.

19. The shock absorbing structure for a vehicle according to claim 9, wherein
the bumper beam has a curved shape in which a central portion in the vehicle width direction is positioned in front of both end portions,
the shock absorbing member has:
a rear bent portion connected with the vehicle-body frame member; and
a front bent portion connected with the bumper beam, and
the rear bent portion is formed on the vehicle-width-direction outer side of the side wall portion, and the front bent portion is formed on the vehicle-width-direction inner side of the side wall portion.

20. The shock absorbing structure for a vehicle according to claim 10, wherein
the bumper beam has a curved shape in which a central portion in the vehicle width direction is positioned in front of both end portions,
the shock absorbing member has:
a rear bent portion connected with the vehicle-body frame member; and
a front bent portion connected with the bumper beam, and
the rear bent portion is formed on the vehicle-width-direction outer side of the side wall portion, and the front bent portion is formed on the vehicle-width-direction inner side of the side wall portion.

21. The shock absorbing structure for a vehicle according to claim 11, wherein
the bumper beam has a curved shape in which a central portion in the vehicle width direction is positioned in front of both end portions,
the shock absorbing member has:
a rear bent portion connected with the vehicle-body frame member; and
a front bent portion connected with the bumper beam, and
the rear bent portion is formed on the vehicle-width-direction outer side of the side wall portion, and the front bent portion is formed on the vehicle-width-direction inner side of the side wall portion.

22. The shock absorbing structure for a vehicle according to claim 12, wherein
the bumper beam has a curved shape in which a central portion in the vehicle width direction is positioned in front of both end portions,
the shock absorbing member has:
a rear bent portion connected with the vehicle-body frame member; and
a front bent portion connected with the bumper beam, and
the rear bent portion is formed on the vehicle-width-direction outer side of the side wall portion, and the front bent portion is formed on the vehicle-width-direction inner side of the side wall portion.
